(19) United States
(12) Patent Application Publication
(10) Pub. No.: US 2012/0321947 A1
(43) Pub. Date: Dec. 20, 2012

(54) LITHIUM SECONDARY BATTERY AND MANUFACTURING METHOD FOR SAME

(76) Inventors: Satoshi Goto, Nishikamo-gun (JP); Kaoru Inoue, Hirakata-shi (JP)

(21) Appl. No.: 13/497,604

(22) PCT Filed: Sep. 25, 2009
(86) PCT No.: PCT/JP09/66600

§ 371 Date: Mar. 22, 2012

(51) Int. Cl. H01M 4/131

(52) U.S. Cl. 429/211; 427/126.6

(57) ABSTRACT

In a lithium secondary battery provided by the present invention, a positive electrode active material is constituted by a lithium composite oxide having at least lithium, nickel, and/or cobalt as main constituent elements, a porosity of a positive electrode active material layer is 30% or more and 40% or less, and a porosity of a negative electrode active material layer is 30% or more and 45% or less. Further, a void volume ratio (Sa/Sb) between a void volume (Sa) per unit area of the positive electrode active material layer and a void volume (Sb) per unit area of the negative electrode active material layer satisfies 0.9≦(Sa/Sb)≦1.4.

### TECHNICAL FIELD

The present invention relates to a lithium secondary battery, and more particularly to a lithium secondary battery that can be used favorably for high rate charging/discharging as a vehicle-installed power supply, and to a method of manufacturing the battery.

### BACKGROUND ART

In recent years, secondary batteries such as lithium secondary batteries and nickel hydrogen batteries have increased in importance as power supplies installed in vehicles that use electricity as a drive source or power supplies installed in personal computers, portable terminals, other electrical appliances, and so on. A lithium secondary battery (typically a lithium ion battery) in particular is lightweight and exhibits high energy density, and may therefore be used favorably as a high output power supply for installation in a vehicle (an automobile, for example, and more particularly a hybrid automobile or an electric automobile).

In a typical constitution of this type of lithium secondary battery, an electrode active material layer (more specifically, a positive electrode active material layer and a negative electrode active material layer) capable of absorbing and releasing lithium ions reversibly is provided on a surface of an electrode collector. In a case of a positive electrode, for example, the positive electrode collector has the positive electrode active material layer which is formed by coating the surface of the positive electrode collector with a paste form composition (the paste form composition includes a slurry form composition; hereafter, this type of composition will be referred to simply as a paste) in the state where a positive electrode active material such as a lithium-transition metal composite oxide is dispersed through an appropriate solvent.

Incidentally, in the usage application of a rechargeable battery, there is one usage assumed to be used in the mode repeating a high rate pulse charging/discharging in which a large current is caused instantaneously, within a short time period. A lithium secondary battery used as a high output power supply installed in a vehicle, for example, is a typical example of this usage application. In a battery used in this manner, a load exerted on the electrode active material layers during movement of a charge carrier is larger than that of a battery used for a household electrical appliance, and therefore, when charging/discharging is performed repeatedly, an internal resistance may increase. Such an increase in the internal resistance may occur when an amount of electrolyte held in voids formed in the electrode active material layers or an ion concentration distribution balance in the electrolyte becomes biased toward one electrode side or the like. This tendency occurs particularly strikingly during high rate pulse charging/discharging. Therefore, attempts have been made to improve a cycle characteristic (a durability) by prescribing the amount of electrolyte held in the voids in the electrolyte active material layers in accordance with a porosity, a void volume, or the like of the electrode active material layers. Patent Documents 1 to 3 may be cited as prior art relating to this point.

Patent Document 1 discloses a lithium secondary battery in which an electrolyte impregnation amount per predetermined area is calculated with respect to a positive electrode active material layer and a negative electrode active material layer as an electrolyte holding capacity, and a relationship between an electrolyte holding capacity (a) of the positive electrode active material layer and an electrolyte holding capacity (b) of the negative electrode active material layer is set to satisfy 0.9≦a/b≦1.3. Patent Document 2 investigates an appropriate amount of electrolyte relative to a total void volume of a positive electrode, a negative electrode, and a separator. Patent Document 3 discloses a lithium secondary battery in which a ratio between a void volume (Vₚ) of a positive electrode active material layer and a void volume (Vₙ) of a negative electrode active material layer satisfies 0.3≦(Vₚ/Vₙ)≦0.5.

### PATENT LITERATURE

Patent Document 1: Japanese Patent Application Publication No. H09-22689
Patent Document 2: Japanese Patent Application Publication No. 2000-294294
Patent Document 3: Japanese Patent Application Publication No. 2003-331825

### SUMMARY OF INVENTION

However, although the prior art cited above investigates optimization of a relative ratio (a ratio) between the porosities or void volumes of the positive electrode active material layer and negative electrode active material layer, it cannot be said that sufficient technical investigation has been applied to favorable void formations in the respective active material layers. For example, in a case where only the relative ratio between the void volumes of the respective electrode active material layers is prescribed, as in Patent Document 1, a total void volume in the negative electrode active material layer increases following an increase in the amount of paste coated onto the negative electrode, and as a result, the void volume of the positive electrode active material layer must also be increased. When the void volume of the positive electrode active material layer increases to or above a predetermined proportion, however, a high density that is required in the positive electrode active material in order to increase the output of the secondary battery cannot be realized, and as a result, an electron conductivity (an ion conductivity) decreases. It is therefore difficult to improve a battery characteristic (a high rate characteristic or the cycle characteristic) simply by manipulating the relative ratio between the void volumes or the porosities of the positive electrode active material layer and the negative electrode active material layer.

The present invention has been designed to solve these conventional problems relating to a lithium secondary battery, and an object thereof is to provide a lithium secondary battery in which respective void volumes of a positive electrode active material layer and a negative electrode active material layer can be adjusted relative to each other such that an increase in an internal resistance is suppressed and a superior battery characteristic (a cycle characteristic or a high rate characteristic) is obtained during use as a high output power supply for a vehicle, and a manufacturing method thereof. Another object of the present invention is to provide a vehicle including this lithium secondary battery.

### Solution to Problem

To achieve the objects described above, the present invention provides a lithium secondary battery that comprises a positive electrode having a positive electrode active material layer including a positive electrode active material and being formed on a surface of a positive electrode collector, and a negative electrode having a negative electrode active material layer including a negative electrode active material and being formed on a surface of a negative electrode collector. The positive electrode active material of the lithium secondary battery according to the present invention is constituted by a lithium composite oxide having at least lithium and nickel and/or cobalt as main constituent elements (of the constituent metallic elements other than the lithium, a molar composition ratio of the nickel and/or the cobalt is typically 50% or more), while a porosity of the positive electrode active material layer is 30% or more and 40% or less and a porosity of the negative electrode active material layer is 30% or more and 45% or less. Further, a void volume ratio (Sa/Sb) between a void volume (Sa) per unit area of the positive electrode active material layer and a void volume (Sb) per unit area of the negative electrode active material layer satisfies 0.9≦(Sa/Sb)≦1.4.

Note that the “lithium secondary battery” according to this specification is a secondary battery that uses lithium ions as electrolyte ions and realizes charging/discharging through movement of the lithium ions between the positive and negative electrodes. A secondary battery generally known as a lithium ion battery serves as a typical example of the lithium secondary battery according to this specification.

Further, the “positive electrode active material” according to this specification is a positive electrode side active material capable of reversibly absorbing and releasing (typically through insertion and elimination) a chemical species (here, lithium ions) serving as a charge carrier in the secondary battery, while the “negative electrode active material” according to this specification is a negative electrode side material capable of reversibly absorbing and releasing the aforesaid chemical species.

Furthermore, the “porosity” according to this specification is a volume ratio of a porous part (a space) existing in the interior of the positive electrode active material layer or the negative electrode active material layer relative to the entire volume of the positive electrode active material layer or the negative electrode active material layer.

According to the present invention, in a lithium secondary battery used in the mode of repeating high rate pulse charging/discharging within a short period, a void formation in the electrode active material layers can be indicated more specifically by being defined multilaterally in terms of the relative ratio between the void volumes of the positive electrode active material layer and the negative electrode active material layer and favorable porosities.

In a lithium secondary battery for a high output power supply used in the mode of repeating high rate pulse charging/discharging within a short period, a reaction in an electrolyte on the positive electrode side during discharging (wherein lithium ions absorbed to the negative electrode side move to the positive electrode side) is diffusion-controlled. The present inventors found that by forming the voids in the positive electrode active material layer to be approximately equal to or greater than the void volume of the negative electrode active material layer, the positive electrode side reaction during discharging enters a diffusion-controlled state, and therefore an increase in internal resistance can be suppressed. Hence, the lithium secondary battery disclosed herein is set such that the void volume ratio (Sa/Sb) between the void volume (Sa) per unit area of the positive electrode active material layer and the void volume (Sb) per unit area of the negative electrode active material layer satisfies 0.9≦(Sa/Sb)≦1.4, the porosity of the positive electrode active material layer is 30% or more and 40% or less, and the porosity of the negative electrode active material layer is 30% or more and 45% or less. As a result, the amount of electrolyte held in the voids is maintained at a favorable level in both of the electrode active material layers, and therefore an ion concentration distribution balance of the electrolyte does not become biased toward one electrode side even during high rate pulse charging/discharging. Accordingly, increases in internal resistance are suppressed. It is therefore possible according to the present invention to provide a lithium secondary battery that exhibits a superior battery characteristic (a cycle characteristic or a high rate characteristic) when used as a high output power supply for a vehicle, and exhibits a particularly favorable low-temperature cycle characteristic under low-temperature pulse charging/discharging conditions.

In a preferred aspect of the lithium secondary battery disclosed herein, the lithium composite oxide constituting the positive electrode active material is a composite oxide represented by a following formula:

Li(Ni₁₋ₓCoₓ)O₂ (1)

(wherein x in Formula (I) satisfies 0<x<0.5).

The positive electrode active material of the lithium secondary battery according to this preferred aspect is constituted by a lithium composite oxide containing nickel, which is inexpensive and has a large theoretical lithium ion absorption capacity, and cobalt for improving an electron conductivity. Further, a molar ratio x of the cobalt in the lithium composite oxide satisfies a relationship of 0<x<0.5, and therefore the molar ratio of the nickel is greater than a molar ratio of the cobalt. Hence, when this lithium composite oxide is used, a lithium secondary battery exhibiting a superior battery characteristic (a cycle characteristic or a high rate characteristic) can be provided.

In another preferred aspect of the lithium secondary battery disclosed herein, the void volume ratio (Sa/Sb) between the void volume (Sa) per unit area of the positive electrode active material layer and the void volume (Sb) per unit area of the negative electrode active material layer satisfies 1≦(Sa/Sb)≦1.1.

When the void volume of the positive electrode active material layer is too small, the reaction in the electrolyte on the positive electrode side during high rate discharging slows, which is undesirable. When the void volume of the positive electrode active material layer is too large, on the other hand, an electrolyte holding amount in the positive electrode active material layer increases excessively, leading to a reduction in the amount of electrolyte held in the voids in the negative electrode active material layer, and as a result, an increase in internal resistance occurs. Therefore, by ensuring that the void volume ratio (Sa/Sb) satisfies 1≦(Sa/Sb)≦1.1, increases in internal resistance can be suppressed even further, making it possible to provide a lithium secondary battery that exhibits an even more superior battery characteristic (a cycle characteristic or a high rate characteristic) and exhibits a particularly favorable low-temperature cycle characteristic during low-temperature pulse charging/discharging.

In another preferred aspect, a layer density of the positive electrode active material layer is 2 g/cm³ or more and 2.5 g/cm³ or less. Here, the “layer density” is a density of a solid forming the positive electrode active material layer.

The void volume of the positive electrode active material layer increases as the layer density of the positive electrode active material layer decreases. Hence, by setting the layer density of the positive electrode active material layer at 2 g/cm³ or more and 2.5 g/cm³ or less in order to diffusion-control the positive electrode side reaction during discharging, the void volume is formed favorably such that charge transfer is performed efficiently. It is therefore possible to provide a lithium secondary battery in which increases in internal resistance are suppressed even when high rate pulse charging/discharging is performed repeatedly.

As another aspect for realizing the objects described above, the present invention provides a method of manufacturing a lithium secondary battery comprising a positive electrode having a positive electrode active material layer including a positive electrode active material and being formed on a surface of a positive electrode collector, and a negative electrode having a negative electrode active material layer including a negative electrode active material and being formed on a surface of a negative electrode collector. In the manufacturing method disclosed herein, a lithium composite oxide having at least lithium and nickel and/or cobalt as main constituent elements (of the constituent metallic elements other than lithium, a molar composition ratio of the nickel and/or the cobalt is typically 50% or more) is used as the positive electrode active material. Further, the positive electrode active material layer is formed such that a porosity thereof is 30% or more and 40% or less, while the negative electrode active material layer is formed such that a porosity thereof is 30% or more and 45% or less. Furthermore, the positive electrode active material layer and the negative electrode active material layer are formed such that a void volume ratio (Sa/Sb) between a void volume (Sa) per unit area of the positive electrode active material layer and a void volume (Sb) per unit area of the negative electrode active material layer satisfies 0.9≦(Sa/Sb)≦1.4.

In a lithium secondary battery used to perform high rate pulse charging/discharging, in which a large current is caused to flow instantaneously, repeatedly within a short time period, the reaction occurring in the electrolyte on the positive electrode side during discharging (where the lithium ions absorbed to the negative electrode side move to the positive electrode side) is diffusion-controlled. The present inventor found that by forming the voids in the positive electrode active material layer to be approximately equal to or greater than the void volume of the negative electrode active material layer, the positive electrode side reaction during discharging enters a diffusion-controlled state, and therefore an increase in internal resistance can be suppressed. Furthermore, when the void volume of the positive electrode active material layer is too large, the amount of electrolyte held in the voids in the positive electrode active material layer becomes excessive, leading to a reduction in an electrolyte holding force of the negative electrode active material layer, which is undesirable. Hence, in the present invention, the positive electrode active material layer and the negative electrode active material layer are formed such that the void volume ratio (Sa/Sb) between the void volume (Sa) per unit area of the positive electrode active material layer and the void volume (Sb) per unit area of the negative electrode active material layer satisfies 0.9≦(Sa/Sb)≦1.4, the porosity of the positive electrode active material layer is 30% or more and 40% or less, and the porosity of the negative electrode active material layer is 30% or more and 45% or less. As a result, the amount of electrolyte held in the voids is favorably maintained in both of the electrode active material layers, and therefore the ion concentration distribution balance of the electrolyte does not become biased toward one electrode side even during high rate pulse charging/discharging. Accordingly, increases in internal resistance can be suppressed. It is therefore possible to provide a method of manufacturing a lithium secondary battery that exhibits a superior battery characteristic (a cycle characteristic or a high rate characteristic) when used as a high output power supply for a vehicle, and exhibits a particularly favorable low-temperature cycle characteristic under low-temperature pulse charging/discharging conditions.

In a preferred aspect of the manufacturing method disclosed herein, a composite oxide represented by a following formula:

Li(Ni₁₋ₓCoₓ)O₂ (1)

(wherein x in Formula (I) satisfies 0<x<0.5) is used as the lithium composite oxide constituting the positive electrode active material.

A preferred aspect of the positive electrode active material constituted by the lithium composite oxide satisfying Formula (I) contains nickel and cobalt as the constituent metallic elements other than the lithium. In a composite oxide containing nickel, a large theoretical lithium ion absorption capacity and a reduction in raw material cost can be realized. Further, the molar ratio of the included cobalt is smaller than the molar ratio of the nickel, and therefore an improvement in electron conductivity can be realized. Hence, when a composite oxide having this composition ratio is used as the positive electrode active material, a lithium secondary battery exhibiting a superior battery characteristic (a cycle characteristic or a high rate characteristic) can be manufactured.

Further, the positive electrode active material layer and the negative electrode active material layer are preferably formed such that the void volume ratio (Sa/Sb) between the void volume (Sa) per unit area of the positive electrode active material layer and the void volume (Sb) per unit area of the negative electrode active material layer satisfies 1≦(Sa/Sb)≦1.1.

By forming the respective active material layers such that the void volume ratio (Sa/Sb) between the positive electrode active material layer and the negative electrode active material layer satisfies 1≦(Sa/Sb)≦1.1, increases in internal resistance can be suppressed even further, and as a result, a lithium secondary battery that exhibits a superior battery characteristic (a cycle characteristic or a high rate characteristic) and a particularly favorable low-temperature cycle characteristic under low-temperature pulse charging/discharging conditions can be manufactured.

In another preferred aspect, the positive electrode active material layer is formed such that a layer density thereof is 2 g/cm³ or more and 2.5 g/cm³ or less.

The void volume of the positive electrode active material layer increases as the layer density (solid density) of the positive electrode active material layer decreases. Hence, by forming the positive electrode active material layer such that the layer density thereof is 2 g/cm³ or more and 2.5 g/cm³ or less in order to diffusion-control the positive electrode side reaction during discharging, a favorable void volume is formed in the positive electrode active material layer. As a result, charge transfer between the electrodes is performed efficiently, making it possible to manufacture a lithium secondary battery in which increases in internal resistance are suppressed even when high rate pulse charging/discharging is performed repeatedly.

The present invention also provides a vehicle including any lithium secondary battery disclosed herein (any lithium secondary battery manufactured by any manufacturing method disclosed herein). As described above, the lithium secondary battery provided by the present invention is capable of exhibiting a particularly suitable battery characteristic (a cycle characteristic or a high rate characteristic) when applied as a battery installed in a vehicle and a particularly favorable low-temperature cycle characteristic during low-temperature pulse charging/discharging. Therefore, the lithium secondary battery disclosed herein can be used favorably as a power supply for a motor installed in a vehicle such as an automobile having a motor, for example a hybrid automobile or an electric automobile.

### BRIEF DESCRIPTION OF THE DRAWINGS

FIG. 1 is a schematic perspective view showing an outer shape of a lithium secondary battery according to an embodiment;

FIG. 2 is a sectional view taken along a II-II line in FIG. 1;

FIG. 3 is a schematic perspective view showing a shape of a 18650 type lithium secondary battery manufactured in an example;

FIG. 4 is a graph showing a relationship between a void volume ratio and a resistance increase rate; and

FIG. 5 is a schematic side view showing a vehicle (an automobile) including the lithium secondary battery according to this embodiment.

### DESCRIPTION OF EMBODIMENTS

A preferred embodiment of the present invention will be described below. Note that matter required to implement the present invention other than items noted particularly in the present specification may be understood as design items to be implemented by a person skilled in the art on the basis of the prior art in the corresponding field. The present invention can be implemented on the basis of the content disclosed in the present specification and technical common knowledge in the corresponding field.

By including the constitutions described above, a lithium secondary battery according to the present invention can be used particularly favorably as a high output power supply. In a lithium secondary battery that is used long-term to perform high rate pulse charging/discharging, in which a large current is caused to flow instantaneously, repeatedly within a short time period, a load exerted on an electrode active material layer during movement of a charge carrier (lithium ions) is large. As a result of the repeated charging/discharging, an amount of electrolyte held in voids formed in the electrode active material layer or an ion concentration distribution balance in the electrolyte may become biased toward one electrode side, leading to an increase in internal resistance. The present inventors focused on the fact that a reaction occurring in the electrolyte on a positive electrode side during discharging (wherein lithium ions absorbed to a negative electrode side move to the positive electrode side) is diffusion-controlled, and found that by defining the lithium secondary battery multilaterally in terms of a relative ratio between void volumes of a positive electrode active material layer and a negative electrode active material layer and favorable porosities thereof, a void formation in the electrode active material layers can be indicated more specifically. As a result, increases in internal resistance can be suppressed.

First, constituent materials of the positive electrode active material layer, which is formed on a surface of a positive electrode collector as a feature of the present invention, will be described. The positive electrode active material layer contains a positive electrode active material that is capable of absorbing and releasing lithium ions.

A lithium composite oxide having at least lithium (Li), nickel (Ni), and/or cobalt (Co) as main constituent elements (of the constituent metallic elements other than the lithium, a total molar composition ratio of the nickel and/or the cobalt is typically 50% or more) is used as the positive electrode active material of the lithium secondary battery disclosed herein.

Further, a composite oxide that contains lithium, nickel, and cobalt as required constituent elements and is represented by a following formula:

Li(Ni₁₋ₓCoₓ)O₂ (1)

(where x in Formula (I) satisfies 0<x<0.5) may be used as a more preferable positive electrode active material. This composite oxide contains nickel, which is inexpensive and has a large theoretical lithium ion absorption capacity, and cobalt for improving an electron conductivity. Further, a composition ratio of this lithium composite oxide is preferably set such that a molar ratio of the nickel is greater than a molar ratio of the cobalt.

Note that the composite oxide described above may contain at least one metallic element in addition to the lithium, nickel, and cobalt, typically in a smaller proportion than the cobalt and the nickel. For example, this element contained in a small amount may be one or more metallic elements selected from a group consisting of aluminum (Al), manganese (Mn), chrome (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce).

Further, a lithium composite oxide powder prepared and provided using a conventional method, for example, may be used as is as the lithium composite oxide. For example, this oxide may be prepared by mixing together several raw material compounds selected appropriately in accordance with an atomic composition at a predetermined molar ratio and baking the resulting mixture using appropriate means. Furthermore, by grinding, granulating, and sorting the baked product using appropriate means, a particulate lithium composite oxide powder substantially constituted by secondary particles having a desired average particle diameter and/or particle size distribution can be obtained. In this embodiment, there are no particular limitations on the particle diameter of the lithium composite oxide.

The positive electrode active material layer may, if necessary, contain desired components such as a conductive material and a binding material in addition to the positive electrode active material described above. A conductive powder material such as carbon powder or carbon fiber may be used favorably as the conductive material. Various types of carbon black, for example acetylene black, furnace black, Ketjen black, graphite powder, and so on, are preferable as the carbon powder. A type of conductive fiber such as carbon fiber or metal fiber, a type of metal powder such as copper powder or nickel powder, an organic conductive material such as a polyphenylene derivate, and so on may also be included either individually or in a mixture. Note that these materials may be used either singly or in combinations of two or more.

A similar material to a binding material used in a positive electrode of a typical lithium secondary battery may be employed appropriately as the binding material. A polymer that can be dissolved or dispersed in a used solvent can be preferably selected. For example, when an aqueous solvent is used, a water-soluble or water-dispersible polymer may be employed favorably, such polymers including: a cellulose-based polymer such as carboxymethyl cellulose (CMC) or hydroxypropyl methyl cellulose (HPMC); polyvinyl alcohol (PVA); a fluorine-based resin such as polytetrafluoroethylene (PTFE) or tetrafluoroethylene-hexafluoropropylene copolymer (FEP); vinyl acetate copolymer; and a type of rubber such as styrene butadiene rubber (SBR) or acrylic acid-modified SBR resin (SBR latex). Further, when a non-aqueous solvent is used, a polymer such as polyvinylidene fluoride (PVDF) or polyvinylidene chloride (PVDC) may be employed favorably. These types of binding materials may be used singly or in combinations of two or more types. Note that the polymer materials cited here may also be used to exhibit a function as a composition thickener or another added material in addition to their function as a binding material.

Either an aqueous solvent or a non-aqueous solvent can be used as the solvent. An aqueous solvent is typically water, but any aqueous solvent having an overall aqueous property, i.e. water or a mixed solvent having water as a main component, can be used favorably. One or more types of an organic solvent (lower alcohol, lower ketone, or the like) that can be mixed evenly with water may be selected appropriately and used as the constituent element of the mixed solvent other than water. For example, an aqueous solvent containing water in a proportion of approximately 80% or more by weight (preferably approximately 90% or more by weight, and more preferably approximately 95% or more by weight) can be used favorably. A solvent substantially constituted by water may be cited as a particularly favorable example. Further, N-methyl-2-pirrylidone (NMP), methylethyl ketone, toluene, and so on may be cited as favorable examples of non-aqueous solvents.

Next, a method of manufacturing the positive electrode of the lithium secondary battery disclosed herein will be described.

A paste form or slurry form positive electrode active material layer forming paste is prepared by mixing the positive electrode active material described above together with a conductive material, a binding material, and so on in an appropriate solvent (an aqueous solvent or a non-aqueous solvent). As regards a mixing ratio of the respective constituent materials, the positive electrode active material preferably occupies approximately 50% or more by weight (typically between 50% by weight and 95% by weight) and more preferably between approximately 70% by weight and 95% by weight (between 75% by weight and 90% by weight, for example) of the positive electrode active material layer, for example. Further, the conductive material may occupy approximately 2% by weight to 20% by weight, and normally occupies approximately 2% by weight to 15% by weight, of the positive electrode active material layer, for example. Furthermore, in a composition using a binding material, the binding material may occupy approximately 1% by weight to 10% by weight, and normally occupies approximately 2% by weight to 5% by weight, of the positive electrode active material layer, for example. The paste prepared by mixing together these constituent materials is coated onto a positive electrode collector 32, whereupon the solvent is dried through vaporization and the resulting component is compressed (pressed). As a result, a positive electrode for a lithium secondary battery in which a positive electrode active material layer is formed on a positive electrode collector is obtained.

A conductive member constituted by a metal that exhibits favorable conductivity may be used favorably as the positive electrode collector onto which the paste is coated. For example, aluminum or an alloy having aluminum as a main component may be used. A shape of the positive electrode collector may be varied in accordance with the shape of the lithium secondary battery and so on and is therefore not particularly limited. A rod shape, a plate shape, a sheet shape, a foil shape, a mesh shape, and various other shapes may be employed.

Note that a similar method to the prior art may be employed appropriately to coat the paste onto the positive electrode collector. For example, the positive electrode collector can be coated favorably with the paste using an appropriate coating apparatus such as a gravure coater, a slit coater, a die coater, or a comma coater. Further, the solvent can be dried favorably using natural drying, hot air, low humidity air, a vacuum, infrared rays, far infrared rays, and an electron beam either singly or in combination. Furthermore, a conventional method such as a roll pressing method or a flat plate pressing method may be employed as the compression method. To perform a thickness adjustment, the thickness may be measured using a film thickness measuring instrument, and compression may be implemented a plurality of times while adjusting a pressing pressure until a desired thickness is obtained.

Respective constituent elements of the negative electrode of the lithium secondary battery according to this embodiment will now be described. The negative electrode disclosed herein includes a negative electrode active material layer including a negative electrode active material that is formed on a surface of a negative electrode collector.

A conductive member constituted by a metal that exhibits favorable conductivity may be used favorably as the negative electrode collector. For example, copper or an alloy having copper as a main component may be used. A shape of the negative electrode collector may be varied in accordance with the shape of the lithium secondary battery and so on, similarly to the positive electrode collector, and is therefore not particularly limited.

One or more materials used conventionally in a lithium secondary battery may be used without any particular limitations as the negative electrode active material. For example, carbon particles may be cited as a favorable example of a negative electrode active material. A particulate carbon material (carbon particles) at least partially having a graphite structure (a layer structure) is preferably used. Any carbon material containing graphite, non-graphitizable carbon (hard carbon), easily graphitizable carbon (soft carbon), or a combination thereof may be used favorably. Of these materials, graphite particles can be used particularly favorably. Graphite particles exhibit superior conductivity and are therefore capable of absorbing the lithium ions serving as the charge carrier favorably. Moreover, graphite particles have a small particle diameter and a large surface area per unit volume, and therefore a negative electrode active material suitable for high rate pulse charging/discharging can be obtained therewith.

Note that in addition to the negative electrode active material described above, various types of polymer materials capable of functioning as the binding material cited above as a constituent element of the positive electrode may be used favorably in the negative electrode active material layer.

Next, a method of manufacturing the negative electrode of the lithium secondary battery will be described.

A paste form or slurry form negative electrode active material layer forming paste is prepared by mixing the negative electrode active material described above together with a binding material and so on in an appropriate solvent (water, an organic solvent, or a mixed solvent thereof). The paste thus prepared is coated onto a negative electrode collector, whereupon the solvent is dried through vaporization and the resulting component is compressed (pressed). As a result, a negative electrode for a lithium secondary battery in which a negative electrode active material layer formed using the aforesaid paste is provided on a negative electrode collector is obtained. Similarly to the method for manufacturing the positive electrode, described above, conventional methods may be used as the coating, drying, and compression methods.

The lithium secondary battery disclosed herein is defined multilaterally in terms of the relative ratio between the void volumes of the positive electrode active material layer and the negative electrode active material layer and favorable porosities thereof.

First, the relative ratio between the void volumes of the positive electrode active material layer and the negative electrode active material layer will be described. In a preferred embodiment of the lithium secondary battery disclosed herein, the positive electrode active material layer and the negative electrode active material layer are formed such that a void volume ratio (Sa/Sb) between a void volume (Sa) per unit area of the positive electrode active material layer and a void volume (Sb) per unit area of the negative electrode active material layer typically satisfies 0.9≦(Sa/Sb)≦1.4, preferably satisfies 1≦(Sa/Sb)≦1.4, and more preferably satisfies 1≦(Sa/Sb)≦1.1. By setting the void volume per unit area of the positive electrode active material layer to be approximately equal to or greater than the void volume per unit area of the negative electrode active material layer, the reaction on the positive electrode side during discharging (wherein the lithium ions absorbed to the negative electrode side move to the positive electrode side) is promoted. As a result, the amount of electrolyte held in the voids can be maintained at a favorable level in the respective electrode active material layers, and therefore an increase in internal resistance can be suppressed even during high rate pulse charging/discharging without bias toward one electrode side in the ion concentration distribution balance of the electrolyte.

A method of calculating the void volume per unit area will now be described. For example, a void volume (mL/cm²) per unit area of the positive electrode active material layer is calculated by first punching out a predetermined area of the positive electrode manufactured as described above using a punch or the like and measuring a weight (g/cm²) of the positive electrode active material layer per unit area. Next, a composition ratio (mixing ratio) of each constituent material (the positive electrode active material, the conductive material, the binding material, and so on, for example) contained in the active material layer is multiplied by the measured weight (g/cm²) of the positive electrode active material layer per unit area to determine a weight (g/cm²) of each constituent material per unit area, whereupon the result is divided by a true specific gravity (g/mL) of each constituent material. Thus, a volume (mL/cm²) of each constituent material per unit area can be determined using a following Equation (2) (Equation (2) is the volume of the positive electrode active material per unit area):

[Volume of positive electrode active material per unit area]=[weight of positive electrode active material layer per unit area]×[mixing ratio of positive electrode active material]/[true specific gravity of positive electrode active material] (2)

The void volume (mL/cm²) of the positive electrode active material layer per unit area can then be determined by subtracting all of the determined volumes (mL/cm²) per unit area of the respective constituent materials from the volume (mL/cm²) of the positive electrode active material layer per unit area. This is shown more specifically in Equation (3):

[Void volume per unit area of positive electrode active material layer]=[volume of positive electrode active material layer per unit area]−{[volume of positive electrode active material per unit area]+[volume of conductive material per unit area]+[volume of binding material per unit area]} (3)

Further, in the lithium secondary battery disclosed herein, the respective porosities of the positive electrode active material layer and the negative electrode active material layer are preferably set as follows. The porosity of the positive electrode active material is typically 30% or more and 40% or less, and preferably 33% or more and 39% or less, while the porosity of the negative electrode active material layer is typically 30% or more and 45% or less, and more preferably 30% or more and 40% or less. The voids in the electrode active material layers are used as a movement path (locations where absorption and release occur) of the charge carrier during charging/discharging in the secondary battery, and therefore a conduction path is formed efficiently in the electrode active material layers set with favorable porosities, leading to an improvement in the conductivity of the lithium secondary battery. The voids may take various shapes depending on the materials used to form the active material layers and the manufacturing method thereof, and any shape may be employed. Typically, a spherical shape or a deformation of a spherical shape is often used.

Furthermore, a layer density of the positive electrode active material layer is typically 2 g/cm³ or more and 2.5 g/cm³ or less, and preferably 2.2 g/cm³ or more and 2.5 g/cm³ or less, for example. The void volume of the positive electrode active material layer normally increases as the layer density of the positive electrode active material later decreases. Therefore, by setting the layer density of the positive electrode active material layer in the above range, thereby ensuring that the positive electrode side reaction during discharging is diffusion-controlled, a favorable void volume is formed, leading to an improvement in the efficiency of charge transfer.

An angular lithium secondary battery will be described below as a specific example of the lithium secondary battery according to the present invention. However, the present invention is not limited to this example. Further, matter required to implement the present invention (for example, a constitution and a manufacturing method of an electrode body including the positive and negative electrodes, the constitution and manufacturing method of the separator and the electrolyte, general techniques relating to the construction of a lithium secondary battery and other batteries, and so on) other than items noted particularly in the present specification may be understood as design items to be implemented by a person skilled in the art on the basis of the prior art in the corresponding field. Note that in the drawings to be described below, identical reference symbols have been allocated to parts and sites exhibiting identical actions, and duplicate description thereof has been omitted or simplified. Further, dimensional relationships (lengths, widths, thicknesses, and so on) in the drawings do not reflect actual dimensional relationships.

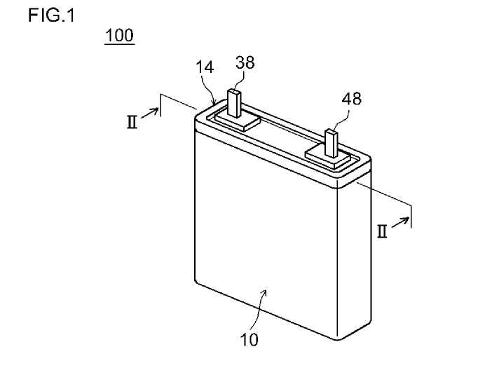

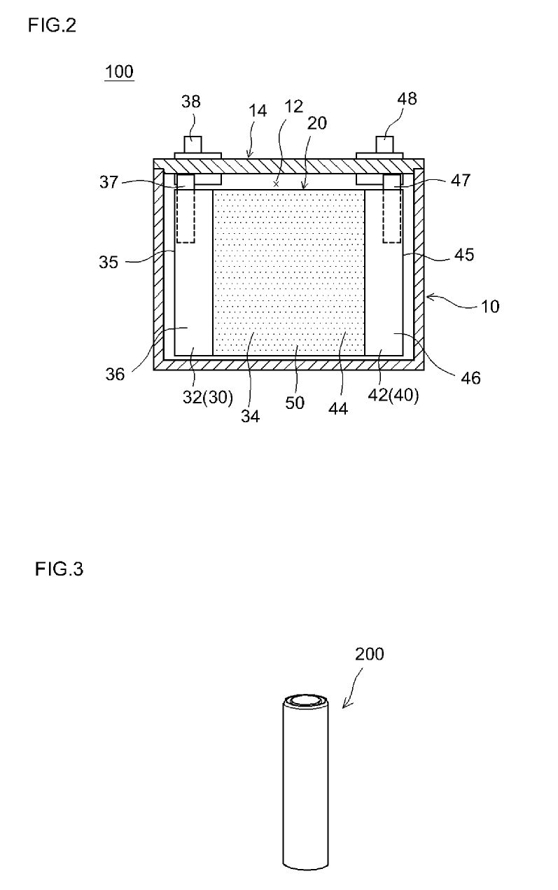

FIG. 1 is a schematic perspective view showing an angular lithium secondary battery according to an embodiment, and FIG. 2 is a sectional view taken along a II-II line in FIG. 1. As shown in FIGS. 1 and 2, a lithium secondary battery 100 according to this embodiment includes an angular battery case 10 taking a rectangular parallelepiped shape, and a lid body 14 that closes an opening portion 12 of the case 10. A flattened electrode body (a wound electrode body 20) and an electrolyte can be housed in an interior of the battery case 10 through the opening portion 12. Further, a positive electrode terminal 38 and a negative electrode terminal 48 for forming external connections are provided on the lid body 14 such that respective parts of the terminals 38, 48 project onto a front surface side of the lid body 14. Furthermore, respective parts of the external terminals 38, 48 are connected to an internal positive electrode terminal 37 and an internal negative electrode terminal 47 in the interior of the case.

As shown in FIG. 2, in this embodiment, the wound electrode body 20 is housed in the case 10. The electrode body 20 is constituted by a positive electrode sheet 30 in which a positive electrode active material layer 34 is formed on a surface of an elongated sheet form positive electrode collector 32, a negative electrode sheet 40 in which a negative electrode active material layer 44 is formed on a surface of an elongated sheet form negative electrode collector 42, and an elongated sheet form separator 50.

Further, one lengthwise direction end portion 35 of the wound positive electrode sheet 30 includes a part (a positive electrode active material layer non-forming portion 36) in which the positive electrode active material layer 34 is not formed such that the positive electrode collector 32 is exposed, and one lengthwise direction end portion 46 of the wound negative electrode sheet 40 includes a part (a negative electrode active material layer non-forming portion 46) in which the negative electrode active material layer 44 is not formed such that the negative electrode collector 42 is exposed. When the positive electrode sheet 30 and the negative electrode sheet 40 are overlapped together with two separators 50, the electrode sheets 30, 40 are overlapped at a slight offset so that the two active material layers 34, 44 are overlapped while the active material layer non-forming portion 36 of the positive electrode sheet and the active material layer non-forming portion 46 of the negative electrode sheet are disposed separately on either lengthwise direction end portion. The four sheets 30, 50, 40, 50 are then wound in this state, whereupon an obtained electrode body is crushed and flattened from a side face direction. As a result, the flattened wound electrode body 20 is obtained.

The internal positive electrode terminal 37 and the internal negative electrode terminal 47 are then joined to the positive electrode active material layer non-forming portion 36 of the positive electrode collector 32 and the exposed end portion of the negative electrode collector 42, respectively, by ultrasonic welding, resistance welding, or the like, and thereby electrically connected respectively to the positive electrode sheet 30 and the negative electrode sheet 40 of the flattened wound electrode body 20. The wound electrode body 20 thus obtained is housed in the battery case 10, whereupon the electrolyte is injected and an injection port is sealed. Thus, the lithium secondary battery 100 according to this embodiment can be constructed. Note that the battery case 10 is not subject to any particular limitations in terms of structure, size, material (a metallic material or a laminate film, for example, may be employed), and so on.

A porous polyolefin-based resin may be used favorably to form the separator sheets 50 provided between the positive and negative electrode sheets 30, 40. For example, a porous separator sheet made of a synthetic resin (a polyolefin resin such as polyethylene, for example) can be used favorably. Note that when a solid electrolyte or a gel-form electrolyte is used as the electrolyte, a separator may not be required (in other words, in this case, the electrolyte itself can function as a separator).

A similar electrolyte to a non-aqueous electrolyte used conventionally in a lithium secondary battery may be employed with no particular limitations as the electrolyte. The non-aqueous electrolyte is typically formed from a supporting electrolyte provided in an appropriate non-aqueous solvent. As the non-aqueous solvent, one or more types selected from a group consisting of propylene carbonate (PC), ethylene carbonate (EC), diethyl carbonate (DEC), dimethyl carbonate (DMC), ethylmethyl carbonate (EMC), and so on, for example, may be used. Further, as the supporting electrolyte, one or more types of lithium compound (lithium salt) selected from LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and so on, for example, may be used. Note that a concentration of the supporting electrolyte in the non-aqueous electrolyte may be similar to that of a non-aqueous electrolyte used in a conventional lithium secondary battery, and is not particularly limited. An electrolyte containing an appropriate lithium compound (a supporting electrolyte) at a concentration of approximately 0.1 mol/L to 5 mol/L may be used.

As described above, the lithium secondary battery thus constructed exhibits a superior battery characteristic (a cycle characteristic or a high rate characteristic) without causing an increase in internal resistance when used as a high output power supply for a vehicle, and exhibits a particularly favorable low-temperature cycle characteristic under low-temperature pulse charging/discharging conditions.

In a following experiment, the lithium secondary battery (a sample battery) disclosed herein was constructed, and a performance thereof was evaluated. Note, however, that the present invention is not limited to the components disclosed in this specific example.

[Experiment 1]

Lithium secondary batteries were constructed by fixing the porosity of the negative electrode active material and varying the porosity of the positive electrode active material.

First, the negative electrode (negative electrode sheet) of the lithium secondary battery was manufactured. More specifically, the negative electrode active material layer forming paste was prepared by mixing together graphite as the negative electrode active material and styrene butadiene rubber (SBR) and carboxy methyl cellulose (CMC) as the binding material in ion-exchanged water such that a weight percentage ratio of the materials was 98:1:1. The prepared paste was then coated onto both surfaces of copper foil having a thickness of approximately 10 μm, serving as the negative electrode collector. Next, moisture in the paste was dried, whereupon the resulting component was stretched into a sheet form using a roll pressing machine such that a negative electrode active material layer having a thickness of approximately 80 μm (both surfaces) was molded. Thus, the negative electrode sheet was obtained. In the negative electrode of the lithium secondary battery obtained in this manner, the layer density of the negative electrode active material layer was 1.34 g/cm³, the porosity was 39%, and the void volume per unit area was 3.0 mL/cm².

Next, the positive electrode (positive electrode sheet) of the lithium secondary battery was manufactured. More specifically, the positive electrode active material layer forming paste was prepared by mixing together a lithium composite oxide (LiNi_{0.8}Cu_{0.2}O₂) powder as the positive electrode active material, acetylene black as the conductive material, and polyvinylidene fluoride (PVDF) as the binding material with N-methylpyrrolidone (NMP) such that the weight percentage ratio of the materials was set variously. The prepared paste was then coated onto both surfaces of sheet form aluminum foil having a thickness of approximately 10 μm, serving as the positive electrode collector. Next, moisture in the paste was dried, whereupon the resulting component was stretched into a sheet form using a roll pressing machine such that a positive electrode active material layer having a thickness of approximately 75 μm (both surfaces) was molded. Thus, positive electrode sheets of Samples No. 1 to No. 8 were obtained. The layer density (g/cm³), the porosity (%), and the void volume per unit area (mL/cm²) of the positive electrode active material layer were then calculated with respect to the positive electrodes of the lithium secondary batteries of Samples No. 1 to No. 8 thus obtained. Table 1 shows data relating to Samples No. 1 to No. 8.

A cylindrical lithium secondary battery having a diameter of 18 mm and a height of 65 mm (a 18650 type), such as that shown in FIG. 3, was then constructed in accordance with following procedures using the negative electrode (negative electrode sheet) having a fixed porosity and the positive electrodes (positive electrode sheets) of Samples No. 1 to No. 8, having different porosities, manufactured as described above. More specifically, a wound electrode body was manufactured by laminating the negative electrode sheet and the positive electrode sheet together with two separators having a thickness of 25 μm and then winding the resulting laminated sheet. The electrode body was housed in a container together with an electrolyte, whereupon an opening portion of the container was sealed. Thus, a total of eight types of lithium secondary batteries (sample batteries) using the different positive electrode sheets of Samples No. 1 to No. 8 were constructed. Note that the used electrolyte was formed by dissolving a supporting electrolyte LiPF₆ at a concentration of 1 mol/L in a mixed solvent of ethylene carbonate (EC) and diethyl carbonate (DEC) having a volume ratio of 3:7.

[Low Temperature Cycle Characteristic]

Next, as an index for evaluating an output characteristic of the respective lithium secondary batteries constructed as described above, a cycle test was performed during high rate pulse charging/discharging under a temperature condition of −15° C., and a post-cycle internal resistance increase rate was checked. More specifically, each battery was adjusted to a charging condition of SOC 60% through constant current-constant voltage (CC-CV) charging under a temperature condition of −15° C., whereupon the battery was discharged at 20 C. A voltage after 10 seconds from the start of charging was then measured, and an I-V characteristic graph was created. An initial internal resistance value (mΩ) at −15° C. was calculated from an incline of the I-V characteristic graph.

Each battery was then adjusted to SOC 60% under similar conditions, whereupon a square wave pulse charging/discharging cycle in which discharging was performed for 10 seconds at 20 C and charging was performed for 100 seconds at 2 C under a temperature condition of −15° C. was repeated for 1000 cycles. An internal resistance value of the battery following 1000 cycles was then measured in a similar manner to the initial internal resistance value, whereupon an internal resistance value increase rate (%) before and after the aforesaid pulse charging/discharging cycle was determined from a following formula: {(post-cycle IV resistance value)/(initial IV resistance value)}×100. The results are shown on Table 1.

TABLE 1

| | POSITIVE ELECTRODE | | | | | |
|---|---|---|---|---|---|---|
| | | MIXING RATIO | | | VOID VOLUME | |
| | LAYER | OF CONDUCTIVE | | VOID | RATIO (POSITIVE | RESISTANCE |
| SAMPLE | DENSITY | MATERIAL | POROSITY | VOLUME | ELECTRODE/NEGATIVE | INCREASE |
| NO. | (g/cm³) | (% BY WEIGHT) | (%) | (mL/cm²) | ELECTRODE) | RATE (%) |
| 1 | 2.3 | 10 | 37 | 3.1 | 1.03 | 1.13 |
| 2 | 2.3 | 8 | 39 | 3.3 | 1.10 | 1.13 |
| 3 | 2.45 | 10 | 33 | 2.6 | 0.87 | 1.33 |
| 4 | 2.45 | 8 | 35 | 2.8 | 0.93 | 1.22 |
| 5 | 2.45 | 6 | 38 | 3.0 | 1.00 | 1.11 |
| 6 | 2.6 | 10 | 28 | 2.1 | 0.70 | 1.71 |
| 7 | 2.6 | 8 | 31 | 2.3 | 0.77 | 1.53 |
| 8 | 2.6 | 6 | 34 | 2.5 | 0.83 | 1.49 |

All of the negative electrodes in the lithium secondary batteries of Samples No. 1 to No. 8 had a layer density of 1.34 g/cm³, a porosity of 39%, and a void volume per unit area of 3.0 mL/cm².

As shown on Table 1, in the lithium secondary batteries in which the void volume ratio (Sa/Sb) between the void volume (Sa) per unit area of the positive electrode active material layer and the void volume (Sb) per unit area of the negative electrode active material layer was 0.93 (Sample No. 4), 1.00 (Sample No. 5), 1.10 (Sample No. 2), and 1.03 (Sample No. 1), the resistance increase rate was less than 1.25, and it was thereby confirmed that an increase in internal resistance could be suppressed even after a high rate pulse charging/discharging cycle under a low temperature condition.

In the lithium secondary batteries in which the void volume ratio was smaller than those of the above samples, i.e. 0.87 (Sample No. 3), 0.83 (Sample No. 8), 0.77 (Sample No. 7), and 0.70 (Sample No. 6), on the other hand, the resistance increase rate was large.

Further, focusing on the porosity of the positive electrode active material layer, the porosity of the positive electrode active material layer in the lithium secondary batteries having a small resistance increase rate was between 35% and 39%, while the layer density was between 2.30 g/cm³ and 2.45 g/cm³. (Note that the porosity of the negative electrode active material layer was 39% in all cases.)

[Experiment 2]

Next, lithium secondary batteries were constructed by fixing the porosity of the positive electrode active material and varying the porosity of the negative electrode active material.

First, the positive electrode (positive electrode sheet) of the lithium secondary battery was manufactured. More specifically, the positive electrode active material layer forming paste was prepared by mixing together a lithium composite oxide (LiNi_{0.8}Co_{0.2}O₂) powder as the positive electrode active material, acetylene black as the conductive material, and polyvinylidene fluoride (PVDF) as the binding material with N-methylpyrrolidone (NMP) such that a weight percentage ratio of the materials was 87:10:3. The prepared paste was then coated onto both surfaces of sheet form aluminum foil having a thickness of approximately 10 μm, serving as the positive electrode collector. Next, moisture in the paste was dried, whereupon the resulting component was stretched into a sheet form using a roll pressing machine such that a positive electrode active material layer having a thickness of approximately 75 μm (both surfaces) was molded. Thus, the positive electrode sheet was obtained. In the positive electrode of the lithium secondary battery thus obtained, the layer density of the positive electrode active material layer was 2.45 g/cm³, the porosity was 10%, and the void volume per unit area was 2.6 mL/cm².

Next, the negative electrode (negative electrode sheet) of the lithium secondary battery was manufactured. More specifically, the negative electrode active material layer forming paste was prepared by mixing together graphite as the negative electrode active material and styrene butadiene rubber (SBR) and carboxy methyl cellulose (CMC) as the binding material in ion-exchanged water such that a weight percentage ratio of the materials was 98:1:1. The paste was then coated onto both surfaces of copper foil having a thickness of approximately 10 μm, serving as the negative electrode collector, such that the layer density of the negative electrode active material layer took various values. Next, moisture in the paste was dried, whereupon the resulting component was stretched into a sheet form using a roll pressing machine such that a negative electrode active material layer having a thickness of approximately 80 μm (both surfaces) was molded. Thus, negative electrode sheets of Samples No. 9 to No. 13 were obtained. The layer density (g/cm³), the porosity (%), and the void volume per unit area was (mL/cm²) of the negative electrode active material layer were then calculated with respect to the obtained negative electrodes of the lithium secondary batteries of Samples No. 9 to No. 13. Table 2 shows data relating to Samples No. 9 to No. 13.

Five types of cylindrical lithium secondary batteries (sample batteries) having a diameter of 18 mm and a height of 65 mm (a 18650 type), such as that shown in FIG. 3, were then constructed by similar procedures to Experiment 1 using the positive electrode (positive electrode sheet) having a fixed porosity and the negative electrodes (negative electrode sheets) of Samples No. 9 to No. 13, having different porosities, manufactured as described above.

[Low Temperature Cycle Characteristic]

Next, as an index for evaluating the output characteristics of the respective lithium secondary batteries constructed as described above, a cycle test was performed during pulse charging/discharging under a temperature condition of −15° C., and the post-cycle internal resistance increase rate was checked using a similar procedure to Experiment 1. The results are shown in Table 2.

TABLE 2

| | | | | VOID VOLUME | |
|---|---|---|---|---|---|
| | NEGATIVE ELECTRODE | | | RATIO (POSITIVE | |
| | LAYER | | VOID | ELECTRODE/ | RESISTANCE |
| SAMPLE | DENSITY | POROSITY | VOLUME | NEGATIVE | INCREASE |
| NO. | (g/cm³) | (%) | (mL/cm²) | ELECTRODE) | RATE (%) |
| 9 | 1.24 | 44 | 3.6 | 0.73 | 1.58 |
| 10 | 1.34 | 39 | 3.0 | 0.88 | 1.40 |
| 11 | 1.44 | 35 | 2.5 | 1.05 | 1.14 |
| 12 | 1.54 | 30 | 2.0 | 1.32 | 1.17 |
| 13 | 1.64 | 25 | 1.6 | 1.66 | 1.25 |

All of the positive electrodes in the lithium secondary batteries of Samples No. 9 to No. 13 had a layer density of 2.45 g/cm³, a porosity of 33%, and a void volume per unit area of 2.6 mL/cm².

As shown on Table 2, in the lithium secondary batteries in which the void volume ratio (Sa/Sb) between the void volume (Sa) per unit area of the positive electrode active material layer and the void volume (Sb) per unit area of the negative electrode active material layer was 1.05 (Sample No. 11) and 1.32 (Sample No. 12), the resistance increase rate was less than 1.25, and it was thereby confirmed that an increase in internal resistance could be suppressed even after a high rate pulse charging/discharging cycle under a low temperature condition.

In Sample No. 9 and Sample No. 10, which had a smaller void volume ratio than the above samples, and Sample No. 13, which had a larger void volume ratio than the above samples, the resistance increase rate was large.

Further, focusing on the porosity of the negative electrode active material layer, the porosity of the negative electrode active material layer in the lithium secondary batteries having a small resistance increase rate was between 30% and 35%. (Note that the porosity of the positive electrode active material layer was 33% in all cases.)

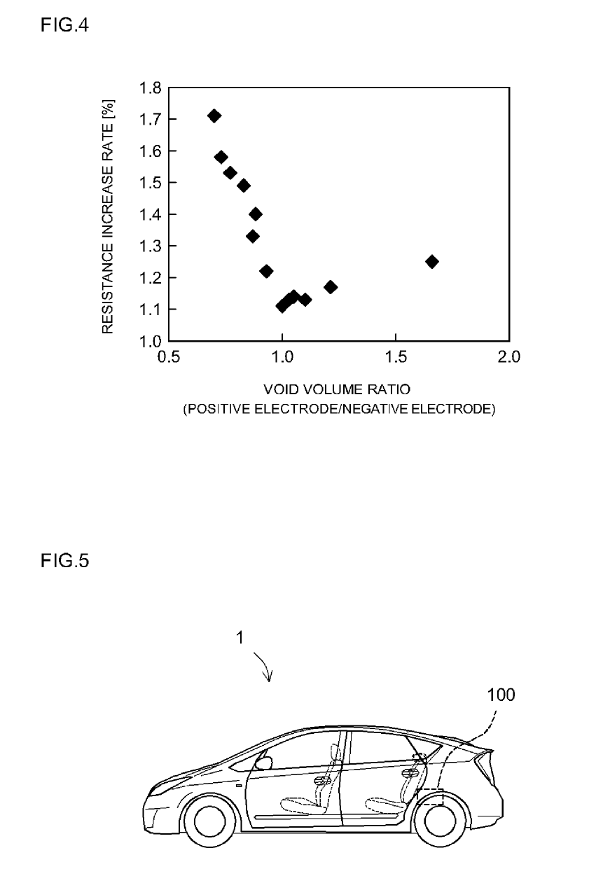

FIG. 4 shows relationships between the void volume ratios and the resistance increase rates of Tables 1 and 2 in the form of a graph. In FIG. 4, an abscissa shows the void volume ratio (Sa/Sb) between the void volume (Sa) per unit area of the positive electrode active material layer and the void volume (Sb) per unit area of the negative electrode active material layer, while an ordinate shows the resistance increase rate.

As is evident from FIG. 4, it was confirmed that in the lithium secondary batteries having a void volume ratio of approximately 0.9 to 1.4, the internal resistance increase rate was small.

The present invention was described in detail above, but the embodiment and example described above are merely examples, and the specific examples of the invention disclosed herein include various amendments and modifications. For example, batteries having various different electrode body constituent materials and electrolytes may be used. Further, a size and other constitutions of the battery may be modified appropriately in accordance with the application (typically installation in a vehicle).

The lithium secondary battery according to the present invention exhibits a superior battery characteristic (a cycle characteristic or a high rate characteristic), as described above, and may therefore be used particularly favorably as a power supply for a motor installed in a vehicle such as an automobile. Therefore, as shown schematically in FIG. 5, the present invention provides a vehicle 1 (typically an automobile, and more particularly an automobile that includes a motor, such as a hybrid automobile, an electric automobile, or a fuel cell automobile) having as a power supply the lithium secondary battery (typically a battery pack in which a plurality of lithium secondary batteries are connected in series) 100 according to the present invention.

1. A lithium secondary battery comprising a positive electrode having a positive electrode active material layer including a positive electrode active material and being formed on a surface of a positive electrode collector and a negative electrode having a negative electrode active material layer including a negative electrode active material and being formed on a surface of a negative electrode collector,
the positive electrode active material being constituted by a lithium composite oxide having at least lithium and nickel and/or cobalt as main constituent elements, and,
a porosity of the positive electrode active material layer being 30% or more and 40% or less and a porosity of the negative electrode active material layer being 30% or more and 45% or less,
wherein a void volume ratio (Sa/Sb) between a void volume (Sa) per unit area of the positive electrode active material layer and a void volume (Sb) per unit area of the negative electrode active material layer satisfies 0.9≦(Sa/Sb)≦1.4.

2. The lithium secondary battery according to claim 1, wherein the lithium composite oxide constituting the positive electrode active material is a composite oxide represented by a following formula:
Li(Ni₁₋ₓCoₓ)O₂ (1)
(wherein x in Formula (I) satisfies 0<x<0.5).

3. The lithium secondary battery according to claim 1, wherein the void volume ratio (Sa/Sb) between the void volume (Sa) per unit area of the positive electrode active material layer and the void volume (Sb) per unit area of the negative electrode active material layer satisfies 1≦(Sa/Sb)≦1.1.

4. The lithium secondary battery according to claim 1, wherein a layer density of the positive electrode active material layer is 2 g/cm³ or more and 2.5 g/cm³ or less.

5. A method of manufacturing a lithium secondary battery comprising a positive electrode having a positive electrode active material layer including a positive electrode active material and being formed on a surface of a positive electrode collector, and a negative electrode having a negative electrode active material layer including a negative electrode active material and being formed on a surface of a negative electrode collector, which comprises:
forming the positive electrode active material layer using, as the positive electrode active material, a lithium composite oxide having at least lithium and nickel and/or cobalt as main constituent elements such that a porosity of the positive electrode active material layer is 30% or more and 40% or less; and
forming the negative electrode active material layer such that a porosity of the negative electrode active material layer is 30% or more and 45% or less,
wherein the positive electrode active material layer and the negative electrode active material layer is formed such that a void volume ratio (Sa/Sb) between a void volume (Sa) per unit area of the positive electrode active material layer and a void volume (Sb) per unit area of the negative electrode active material layer satisfies 0.9≦(Sa/Sb)≦1.4.

6. The manufacturing method according to claim 5, wherein a composite oxide represented by a following formula:
Li(Ni₁₋ₓCoₓ)O₂ (1)
(wherein x in Formula (I) satisfies 0<x<0.5)
is used as the lithium composite oxide constituting the positive electrode active material.

7. The manufacturing method according to claim 5, wherein the positive electrode active material layer and the negative electrode active material layer are formed such that the void volume ratio (Sa/Sb) between the void volume (Sa) per unit area of the positive electrode active material layer and the void volume (Sb) per unit area of the negative electrode active material layer satisfies 1≦(Sa/Sb)≦1.1.

8. The manufacturing method according to claim 5, wherein the positive electrode active material layer is formed such that a layer density of the positive electrode active material layer is 2 g/cm³ or more and 2.5 g/cm³ or less.

9. A vehicle comprising the lithium secondary battery according to claim 1.

10. A vehicle comprising a lithium secondary battery manufactured by the manufacturing method according to claim 5.
